(19) United States
(12) Patent Application Publication
(10) Pub. No.: US 2016/0179097 A1
(43) Pub. Date: Jun. 23, 2016

(54) Unmanned Aerial Vehicle and a Method for Landing the Same

(71) Applicants: SINGAPORE TECHNOLOGIES AEROSPACE LTD, Paya Lebar (SG); DSO NATIONAL LABORATORIES, Singapore (SG)

(72) Inventors: Chee Nam Chua, Singapore (SG); Junwei Choon, Singapore (SG); Kok Yong Lim, Singapore (SG)

(73) Assignees: Singapore Technologies Aerospace Ltd, PayaLebar (SG); DSO National Laboratories, Singapore (SG)

(21) Appl. No.: 14/901,661

(22) PCT Filed: Jun. 24, 2013
(86) PCT No.: PCT/SG2013/000260

§ 371 Date: Dec. 28, 2015

(51) Int. Cl. G05D 1/06; G05D 1/00; B64C 25/32; B64C 39/02

(52) U.S. Cl. CPC G05D 1/0676; B64C 39/024; G05D 1/0011; B64C 25/32; B64C 2201/146

(57) ABSTRACT

Various embodiments provide a method for landing an unmanned aerial vehicle (UAV) in the presence of a wind. The method comprises: performing a first flare-maneuver whilst the UAV is flying. The flare-maneuver causes a front portion of the UAV to rise with respect to a rear portion of the UAV. The method also comprises steering the UAV along a path heading into a direction of the wind. The method further comprises performing a second flare-maneuver before the UAV impacts a landing surface to land. Various embodiments provide a corresponding UAV.

### TECHNICAL FIELD

Various embodiments relate an unmanned aerial vehicle and a method for landing the same.

### BACKGROUND

An unmanned aerial vehicle (UAV) is an aerial vehicle that does not carry a human operator. UAVs can fly autonomously or be piloted remotely, for example, from a base station. UAVs may be used for reconnaissance applications. A UAV's recovery requirements may require the UAV to land in a confined area since UAVs are often operated in an environment with no runway or with obstacles, such as, trees and buildings. Accordingly, UAVs may be required to possess the ability to land precisely with minimal drifting distance.

Known methods for landing of UAVs include belly landing and parachute landing. Parachute landing permits minimal control once the parachute is deployed, but it is easy to operate. However, landing accuracy of this method is very much dependent on wind conditions due to the large air drag associated with the parachute. Also, folding of the parachute has to be performed carefully to prevent entanglement. In belly landing, a reasonable amount of runway is required for the UAV to make its approach and to land safely. Therefore, this method may not be suitable if the UAV is operating in forested areas or cities. Also, the UAV is vulnerable to flipping over due to the high forward speed of the UAV when belly landing.

U.S. Pat. No. 8,123,162 discloses a UAV including an engine and an airframe, including means for performing a deep stall maneuver, at least one inflatable sleeve connected or connectable to the airframe, and means for inflating the sleeve during flight, wherein the inflated sleeve extends along the lower side of the airframe so as to protect same during deep stall landing. A method for operating an Unmanned Air Vehicle (UAV), including an engine and an airframe is also provided. Since this method uses a deep-stall maneuver, it is difficult to control the UAV during landing after the deep stall maneuver has been performed. Therefore, landing accuracy can be low with this method. Also, due to the impact force at landing, this method is not suitable for heavier UAVs which would damage on impact or would require an unfeasibly large inflatable sleeve.

### SUMMARY

A first aspect provides a method for landing an unmanned aerial vehicle (UAV) in the presence of a wind, the method comprising: performing a first flare-maneuver whilst the UAV is flying, the flare-maneuver causing a front portion of the UAV to rise with respect to a rear portion of the UAV; steering the UAV along a path heading into a direction of the wind; and performing a second flare-maneuver before the UAV impacts a landing surface to land.

In an embodiment, the method further comprises inflating an inflatable sleeve connected to an underside of the UAV.

In an embodiment, the step of inflating is performed at the same time as performing the first flare-maneuver.

In an embodiment, the step of steering is performed only after performing the first flare-maneuver.

In an embodiment, the first flare-maneuver is performed when the UAV is at an altitude of between 50-110 meters.

In an embodiment, the second flare-maneuver is performed when the UAV is at an altitude of between 5-40 meters.

In an embodiment, the altitude at which the first flare-maneuver and/or the second flare-maneuver are/is performed is dependent on a speed of the UAV.

In an embodiment, the method further comprises: leveling the UAV so that a lateral axis of the UAV is parallel with respect to the landing surface.

In an embodiment, the step of leveling is performed only after performing the first flare-maneuver and before performing the second flare-maneuver.

In an embodiment, the front portion of the UAV rises by 50-60 degrees from horizontal with respect to the rear portion of the UAV during the first flare-maneuver and/or the second flare-maneuver.

In an embodiment, the front portion is a nose portion of the UAV and the rear portion is a tail portion of the UAV.

In an embodiment, the method further comprises: calculating a first-flare maneuver position based on a desired landing position and the direction of the wind, the first-flare maneuver position being a position at which the first-flare maneuver is to be performed; and flying the UAV to the first-flare maneuver position before the step of performing the first flare-maneuver.

In an embodiment, the method further comprises: calculating a loiter position based on the first-flare maneuver position, the loiter position being a predetermined distance away from the first-flare maneuver position; and flying the UAV to the loiter position before the step of flying the UAV to the first-flare maneuver position.

In an embodiment, the method further comprises: recalculating the first flare-maneuver position based on an updated speed and/or the direction of the wind before the step of performing the first flare-maneuver.

In an embodiment, the first flare-maneuver position includes a latitude value, a longitude value and an altitude value.

A second aspect provides an unmanned aerial vehicle (UAV) comprising: a controller; a detector configured in use to detect and calculate determine a wind direction when the UAV is flying in the presence of a wind and to provide a wind direction indication to the controller; and a steering and propulsion apparatus configured in use to steer and propel the UAV in flight in response to receiving instructions from the controller; wherein the controller is configured in use to instruct the steering and propulsion apparatus to cause the UAV to: perform a first flare-maneuver whilst flying, the flare-maneuver causing a front portion of the UAV to rise with respect to a rear portion of the UAV, steer into the wind direction based on the wind direction indication, and perform a second flare-maneuver before the UAV impacts a landing surface to land.

In an embodiment, the UAV further comprises: an inflatable sleeve connected to an underside of the UAV, the inflatable sleeve being configured in use to inflate in response to receiving an instruction from the controller.

In an embodiment, the UAV further comprises: a transceiver for exchanging data with a remote base station, the transceiver being capable of receiving position information from the remote base station and providing the position information to the controller, wherein the controller is configured in use to instruct the steering and propulsion apparatus to steer and/or propel the UAV in flight based on the position information.

In an embodiment the controller is configured in use to calculate updated position information based on the wind direction indication and to instruct the steering and propulsion apparatus to steer and/or propel the UAV in flight based on the updated position information.

In an embodiment the controller is configured in use to instruct the steering and propulsion apparatus to level the UAV so that a lateral axis of the UAV is parallel with respect to the landing surface.

In an embodiment the detector is further configured in use to detect a wind speed and to provide a wind speed indication to the controller, and the controller is further configured in use to instruct the steering and propulsion apparatus to steer and/or propel the UAV in flight based on the wind speed indication.

### BRIEF DESCRIPTION OF THE DRAWINGS

Embodiments of the invention will be better understood and readily apparent to one of ordinary skill in the art from the following written description, by way of example only, and in conjunction with the drawings, wherein like reference signs relate to like components, in which:

FIG. 1(a) is picture of a UAV in accordance with an embodiment, and FIG. 1(b) is a schematic diagram of the UAV in accordance with an embodiment;

FIG. 2 is a flow diagram of a method for landing a UAV in accordance with an embodiment;

FIG. 3 is a flow diagram of a method for landing a UAV in accordance with an embodiment;

FIG. 4 illustrate roll and pitch plots of a UAV during landing in accordance with an embodiment;

FIG. 5 illustrate a schematic diagram of a heading to rudder control in accordance with an embodiment;

FIG. 6 illustrate a schematic diagram of a method for landing a UAV in accordance with an embodiment;

FIG. 7 illustrate speed plots of a UAV during landing in accordance with an embodiment;

FIG. 8 is a table of landing distance errors for five trial landing operations;

### DETAILED DESCRIPTION

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Various embodiments relate to an unmanned aerial vehicle (UAV) and a method for landing the same.

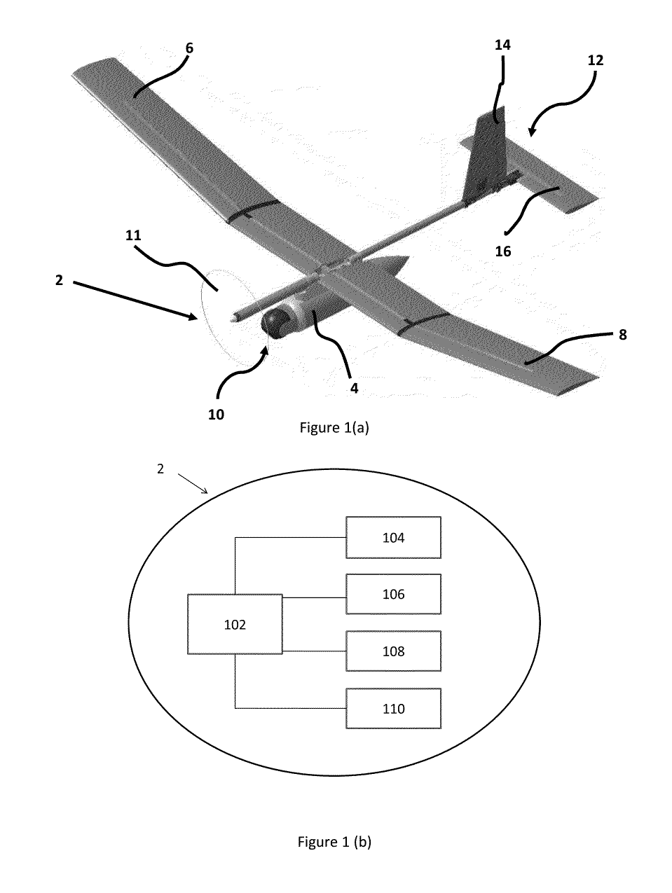

FIG. 1(a) shows a UAV 2 in accordance with an embodiment. The UAV 2 comprises a fuselage 4 and wings 6, 8 attached either side of the fuselage. In an embodiment, wings 6 and 8 may be joined together and be fixed to a top surface of the fuselage 4, as shown in FIG. 1(a). However, in some alternative embodiments, a different configuration may be used, for example, each wing 6, 8 may extend from opposite side portions of the fuselage 4. The fuselage 4 may comprise a front portion 10 and a rear portion 12. The front portion 10 may be a nose portion. The front portion 10 may include a propeller 11 connected to an engine. In use, the engine may cause the propeller 11 to rotate to propel the UAV 2 in a forward direction. The wings 6, 8 may generate a lift force when the UAV is propelled so that the UAV 2 takes off and flies. The rear portion 12 may be a tail portion. The rear portion 12 may further comprise a rudder 14 for controlling a direction (i.e. heading or bearing) and roll of the UAV in flight. The rear portion 12 may further comprise an elevator 16 for controlling a pitch of the UAV in flight.

FIG. 1(b) shows a schematic diagram of the UAV 2 to further illustrate features of the UAV 2, some of which are not visible in FIG. 1(a). The UAV 2 comprises a controller 102, a steering and propulsion apparatus 104 and a detector 106. The UAV 2 may also comprise an inflatable sleeve 108 and a transceiver 110.

In an embodiment, the steering and propulsion apparatus 104 may comprise control surfaces of the UAV 2, e.g. an elevator surface and a rudder surface. Changing the deflection of the elevator surface may be used to control rotation of the UAV about its lateral axis which passes through the UAV from one wingtip to the other wingtip. The rotation about this lateral axis is called ‘pitch’. ‘Pitch’ changes the vertical direction that the UAV's nose is pointing. Changing the deflection of the rudder surface may be used to control the heading (or direction or bearing) of the UAV, i.e. the x-y direction that the UAV is flying. The rudder deflection may be also in turn used to control rotation of the UAV about its longitudinal axis which passes through the UAV from nose to tail. The rotation about this longitudinal axis is called ‘roll’. ‘Roll’ changes the orientation of the UAV's wings with respect to the downward force of gravity.

In an embodiment, the steering and propulsion apparatus 104 may comprise the above-mentioned propeller 11, engine, rudder 14 and elevator 16. The steering and propulsion apparatus 104 is configured in use to steer and propel the UAV 2 in flight in response to receiving instructions from the controller 102. The detector 106 is configured in use to determine a wind direction when the UAV is flying in the presence of a wind and to provide a wind direction indication to the controller 102. In an embodiment, the detector may be capable of detecting a wind speed and provide a wind speed indication to the controller 102. It is to be understood that the detector 106 may be capable of detecting many different variables (i.e. parameters). Non-limiting examples of such variables include: a UAV roll angle, a UAV yaw rate (i.e. angular velocity), a UAV speed, and UAV altitude, a UAV direction (i.e. bearing or heading), a wind speed, and/or wind direction. The detector 106 may include one or more sensors (e.g. a GPS sensor), wherein each sensor is capable of measuring one or more variables. In this way, the detector 106 may monitor multiple different variables simultaneously. Also, the detector 106 may be configured in use to provide indications of variables to the controller 102. Each indication may provide an indication of the value of only one variable or of multiple variables. The controller 102 may obtain this information and use it in instructing the steering and propulsion apparatus 104 on how to fly (i.e. steer and propel) the UAV 2. The detector 106 may determine a variable directly, such as, by directly detecting its value. Additionally or alternatively, the detector 106 may determine a variable indirectly, such as, by calculating its value based on one or more other directly detected values.

In operation, the controller 102 is configured in use to instruct the steering and propulsion apparatus 104 to cause the UAV 2 to perform a first flare-maneuver whilst the UAV 2 is flying. To perform a flare-maneuver, the controller 102 sends an instruction to the steering and propulsion apparatus 104 to cause the front portion 10 of the UAV 2 to rise with respect to a rear portion 12 of the UAV. For example, this operation may be performed by causing elevator 16 to move (i.e. deflect) to cause the pitch of the UAV 2 to change as desired. An effect of this first flare-maneuver is to reduce the speed of the UAV 2 in preparation for landing.

Additionally, the controller 102 is configured in use to instruct the steering and propulsion apparatus 104 to cause the UAV 2 to steer into the wind direction based on the wind direction indication received by the controller 102 from the detector 106. For example, the detector 106 detects the wind direction and sends a wind direction indication to the controller 102, wherein the wind direction indication indicates the wind direction. On receipt of the wind direction indication from the detector 106, the controller 102 may cause the rudder 14 to move (i.e. deflect) to cause the direction of the UAV 2 to change in order that the UAV 2 heads in to the wind direction. In an embodiment, elevator 16 may also be deflected to steer the UAV 2. In an embodiment, the amount of deflection of the rudder and/or the elevator is dependent on the magnitude of the wind indicated by the wind direction indication. In an embodiment, the UAV 2 may fly exactly or substantially into the wind direction. An effect of steering the UAV 2 into the wind is to increase lift to further reduce the speed of the UAV 2 in preparation for landing. Also, since the UAV 2 is heading into the wind, the wind does not cause the UAV 2 to drift off course. In this way, landing accuracy can be improved.

Additionally, the controller 102 is configured in use to instruct the steering and propulsion apparatus 104 to cause the UAV 2 to perform a second flare-maneuver before the UAV impacts a landing surface to land. This second flare-maneuver may be performed in a similar manner to as described above. An effect of this second flare-maneuver is to further reduce the speed of the UAV 2 in preparation for landing. Accordingly, the UAV 2 may land with low velocity such that no (or only a very small) runway is necessary and there is a low chance that the UAV 2 will flip over on impact.

It is to be understood that an advantage of using the above-described double flare-maneuver operation is that the flight path of the UAV 2 can be controlled throughout the landing operation. This is in contrast to other landing schemes, such as, a parachute landing or deep-stall maneuver landing, where control of the UAV during the landing operation is minimal or not possible. In this way, the above-described double flare-maneuver operation can provide superior landing accuracy compared to the other landing methods. This effect is more significant as the wind speed during the landing operation increases.

As mentioned above, the UAV 2 may comprise the inflatable sleeve 108. The inflatable sleeve 108 may be connected to an underside of the UAV 2. The inflatable sleeve 108 may be configured in use to inflate in response to receiving an instruction from the controller 102. In this way, the inflatable sleeve 108 may be inflated before landing so that it acts as an airbag on which the UAV 2 can land to avoid damage to the UAV 2. In an embodiment, the controller 102 may cause the inflatable sleeve 108 to inflate when the first flare-maneuver is performed.

As mentioned above, the UAV 2 may also comprise a transceiver 110 for exchanging data with a base station (e.g. a ground control station). The base station may be static (e.g. in an office or in a building) or mobile (e.g. a person with a remote control or another aerial vehicle). The transceiver 110 may be in communication with the controller 102. The transceiver 110 may be capable of receiving position information from the base station. The position information may identify a position to which the UAV 2 should fly, such as, for example, a landing position, a first flare-maneuver position, a second flare-maneuver position. In an embodiment, the controller 102 may use the position information to calculate a position to fly to. In an embodiment, the controller 102 may perform this calculation based on a variable measured by the detector 106, such as, wind speed and/or direction.

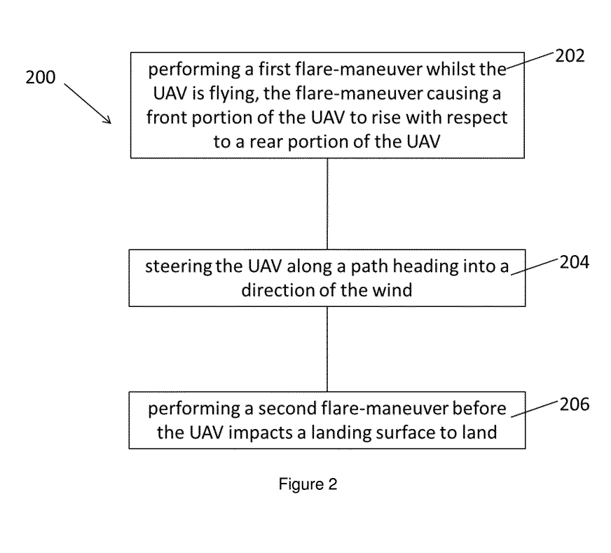

FIG. 2 shows a flow diagram of a method for landing a UAV whilst the UAV is flying in the presence of a wind in accordance with an embodiment.

At 202, the UAV performs a first flare-maneuver. It should be understood that in the present embodiment the first flare-maneuver is performed in the presence of a wind; however, in some other embodiment, the first flare-maneuver could be performed in the absence of a wind. In this case, a predetermined or default wind direction could be used. As mentioned above, the flare-maneuver causes a front portion of the UAV to rise with respect to a rear portion of the UAV. The controller 102 may cause the steering and propulsion apparatus 106 to cause the front portion 10 of the UAV 2 to rise by a number of degrees from horizontal with respect to the rear portion 12 of the UAV 2. This action may be performed by causing a certain amount of deflection of an elevator surface (e.g. 16), as mentioned above. The amount of deflection (and the degrees risen by the front portion 10) may be predetermined and/or may be calculated based on a variable monitored by the detector 106, such as, a speed of the UAV 2 and/or a wind speed. For example, the deflection may cause the front portion 10 to rise from horizontal with respect to the rear portion 12 by about 40-70 degrees, about 50-60 degrees, about 55-60 degrees or about 55 degrees. In an embodiment, the rise angle may be measured with respect to a direction of movement of the fluid (e.g. air) through which the UAV 2 is moving. In an embodiment this direction may be horizontal. In an embodiment, the rise angle does not cause the UAV 2 to perform a stall maneuver, for example, a deep-stall maneuver. Accordingly, an angle of attack of the UAV 2 is kept below a critical angle of attack, i.e. the angle at which stall occurs. In this way, it is possible to maintain control of the UAV 2.

The first flare-maneuver may be performed when the UAV 2 is at an altitude of within a first altitude range. The first altitude range may be predetermined or may be calculated (e.g. dynamically) based on a variable monitored by detector 106, such as, the speed of the UAV and/or the wind speed. For example, the first altitude range may be within about 50-110 meters or about 80-100 meters. The first flare-maneuver may be performed at 90 meters.

In an embodiment, the speed of the UAV 2 is intended to mean a forward speed of the UAV 2 while it is flying in the presence of the wind. The speed of the UAV 2 is decreased upon the performance of the first flare-maneuver. In this way, the first flare-maneuver is used to slow down the UAV 2 before landing.

At 204, the UAV 2 is steered along a path heading into the wind. By steering the UAV 2 into the wind direction, lift and drag is increased. Accordingly, the speed of the UAV 2 is further decreased. The UAV 2 may only be steered into the wind after the first flare-maneuver is performed. To effect this steering, the pitch, roll and direction of the UAV 2 may be controlled via the rudder 14 and the elevator 16, in response to instructions from the controller 102.

In an embodiment, the UAV 2 may be leveled so that a lateral axis of the UAV 2 is horizontal with respect to a landing surface. In an embodiment, the lateral axis is the axis running from the tip of wing 6 to the tip of wing 8. In an embodiment, leveling may be performed by deflecting the rudder 14. Leveling may be performed only after the first flare-maneuver and before the second flare-maneuver. By leveling the UAV 2, the UAV 2 will be level with the landing surface when it impacts the landing surface to land. In this way, damage to the UAV 2 when it lands is reduced.

At 206, the UAV 2 performs a second flare-maneuver before the UAV 2 impacts the landing surface to land. The second flare-maneuver further reduces the speed of the UAV 2. Accordingly, when the UAV 2 lands, it has low forward velocity and so requires no runway, or only a very small runway. Also, the UAV 2 is less likely to flip over when it impacts the landing surface. The second flare-maneuver may be performed when the UAV 2 is at an altitude of within a second altitude range. The second altitude range may be predetermined or be calculated based on a variable monitored by the detector 106, such as, the speed of the UAV 2 and/or the wind speed. For example, the second altitude range may be about 5-40 meters or about 20-30 meters. The second flare-maneuver may be performed at 25 meters. In an embodiment, the landing surface may be any surface on which the UAV 2 can land, for example, a ground surface, a boat surface, a floating platform surface, a suspended surface, or the like. The landing surface may be substantially horizontal.

In an embodiment, an inflatable sleeve connected to an underside of the UAV 2 is inflated. The inflatable sleeve may be inflated by any suitable means, such as, an electric pump, a pressurized fluid container or the like. In use, the inflatable sleeve provides a cushion (i.e. airbag) when the UAV 2 lands so that the landing impact does not damage the UAV 2. The inflatable sleeve may be inflated at same time as performing the first flare-maneuver. The amount of inflation may be dependent on a weight of the UAV 2. For example, the inflatable sleeve may be fully inflated if the UAV 2 is fully loaded, i.e. at maximum weight. In an embodiment, the maximum value of the UAV's weight may be 8 kg. Alternatively, the inflatable sleeve may be only partially inflated when the UAV is unloaded, or only partially loaded, i.e. at minimum or low weight.

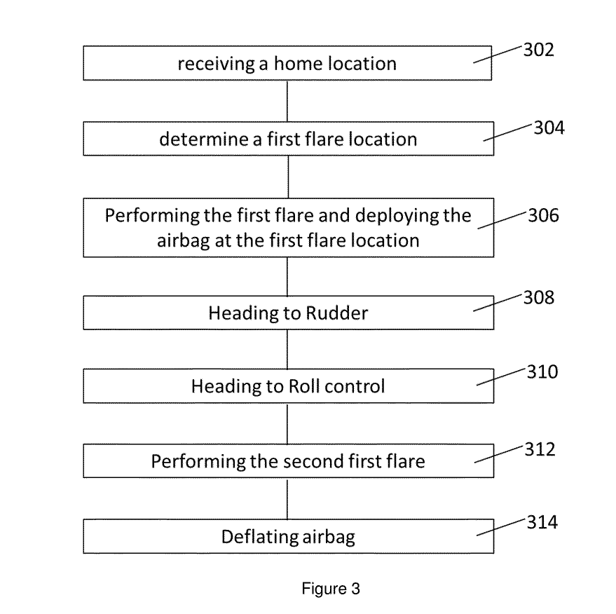

Now referring to FIG. 3, the landing of the UAV 2 in accordance with an embodiment will be described in more detail.

At 302, the transceiver 110 of the UAV 2 may receive a home location (i.e. a landing position) from the base station. This act may signify that recovery (i.e. landing) of the UAV 2 has been commanded by the base station. In an embodiment, positions/locations are specified as a latitude, longitude and altitude.

At 304, a first flare-maneuver position associated with the landing position may also be received by the transceiver 110 from the base station. Additionally or alternatively, the first flare-maneuver position may be calculated by the controller 102 based on the landing position and one or more variables monitored by the detector 106, such as, the wind speed and/or direction or the UAV speed and/or direction. The first flare-maneuver position is the position at which the first flare maneuver position will be performed. For example, the first flare maneuver position may be a fixed distance from the landing position, e.g. 500 meters. Also, the first flare-maneuver position may be downwind of the landing position, so that the UAV 2 can travel to the landing position against the wind.

A loiter position associated with the first flare-maneuver position may also be received by the transceiver 110 from the base station. Additionally or alternatively, the loiter position may be calculated by the controller 102 based on the first flare-maneuver position and one or more variables monitored by the detector 106, such as, the landing position, the wind speed and/or direction or the UAV speed and/or direction. For example, the loiter position may be a fixed distance from the first flare-maneuver position, e.g. 500 meters. Also, the loiter position may be downwind of the first flare-maneuver position, so that the UAV 2 can travel to the first flare-maneuver position against the wind.

In this way, the UAV 2 can fly to the loiter position on any path. Once at the loiter position, the UAV 2 can fly to the first flare-maneuver position whilst heading into the wind. Once at the first flare-maneuver position, the UAV 2 can perform a first flare maneuver and then fly to the landing position whilst heading into the wind. Therefore, the loiter position and the first flare-maneuver position may be determined based on the wind direction.

In any case, upon determination of the home location, the first flare-maneuver position and the loiter position, the UAV 2 may begin heading towards the loiter position. Upon arrival at the loiter position, the UAV 2 may perform a loiter maneuver (e.g. loitering around the loiter position in a holding pattern), as well as descending to the first flare-maneuver location altitude.

On route to, at and/or around the loiter position the UAV 2 may recalculate the first flare-maneuver location based on updated variables from the detector 106, such as, an updated wind speed and/or an altitude of the UAV 2. The UAV 2 may fly to the updated first flare-maneuver position, rather than the first flare-maneuver position calculated or received previously.

At 306, upon arrival at the first flare-maneuver location, the UAV 2 performs a first flare-maneuver. As mentioned above, the first flare-maneuver may be performed by deflecting the elevator 16. The inflatable sleeve may be inflated at the same time as performing the first flare-maneuver.

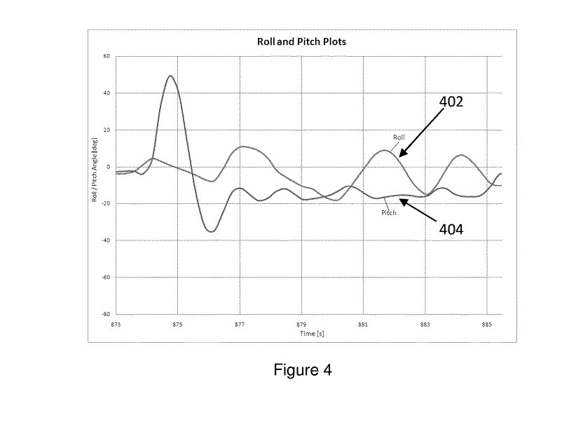

Referring to FIG. 4, roll plot 402 and pitch plot 404 are plotted against time. It can been seen that during the first flare-maneuver the pitch reaches to a maximum of about 50 degrees (at about 875^{th} second) and goes down to a minimum of about −35 degrees (at about 876^{th} second). Also, the pitch gradually stabilizes after the first flare-maneuver and fluctuates between about −10 degrees and about −20 degrees, i.e. the UAV 2 is generally descending. The roll is almost zero degree during the first flare-maneuver and then fluctuates about zero degrees and slowly stabilizes towards the end of the plot. Accordingly, the UAV 2 is leveled with respect to the landing surface and thus the potential damage to the UAV 2 when landing is reduced.

As mentioned, the first flare-maneuver can be performed by controlling an elevator surface of the UAV, for example, deflecting the elevator surface up. In other words, the first flare-maneuver may involve performing an elevator deflection. A speed of the UAV 2 is significantly reduced upon performing the first flare-maneuver, for example, the average forward speed may be reduced from about 18-19 m/s to about 7-8 m/s.

Referring back to FIG. 3, at 308, a ‘Heading to Rudder’ control may be utilized. This control may only be used after the first flare-maneuver. According to this control, the UAV 2 is controlled to head into the wind direction. This can be done by controlling the rudder 14 of the UAV 2. As the UAV 2 is heading towards wind, lift generation is increased to maintain a consistently low decent speed of the UAV 2. In this way, rudder control may be active with speed gain scheduling to steer the UAV heading towards the wind direction. The speed gain scheduling may be implemented based on the speed of the UAV 2. As the speed of the UAV 2 decreases after the first flare-maneuver, the speed gains for the rudder control are increased. The speed gain scheduling may perform automatic tuning of gains by taking the speed of the UAV 2 as an input and changing Proportional (P) and Integral (I) gains of a control loop. In an embodiment, ‘gain’ is a proportional value that shows the relationship between the magnitude of the input to the magnitude of the output signal at steady state.

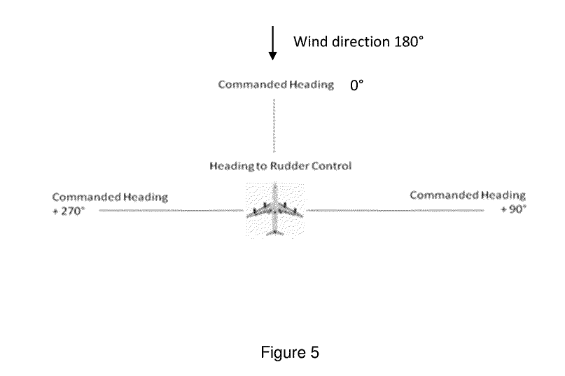

In an embodiment, in the ‘Heading to Rudder’ control, a heading region check may be performed. As shown in FIG. 5, if the wind direction is defined as coming from heading 180° with respect to the UAV 2, a direction into the wind direction is defined as heading 0°, its clockwise perpendicular direction is defined as heading 90° and its anti-clockwise perpendicular direction is defined as heading 270°. In the heading region check, the rudder 14 may be held at its maximum corrective rudder deflection when the UAV is out of its heading region, i.e. greater than heading +90° but less than +270°. For example, if the UAV 2 should be flying at heading 0°, but instead is flying at a heading of a greater angle (e.g. 220°), the rudder 14 may be deflected at its maximum deflection angle until the heading of the UAV 2 enters the region between +90° to +270°, at which time the rudder 14 may be deflected by the amount required to fly the UAV 2 at heading 0°. Alternatively, if the UAV 2 should be flying at heading 0°, but instead is flying at a lesser angle (e.g. 80°), the rudder 14 may be deflected by the amount required to fly the UAV 2 at heading 0°. In this manner, excessive steering which could result in the UAV spiraling can be avoided. As mentioned above, the controller 102 may use the detector 106 to monitor the speed, heading, yaw rate and altitude. These values may be used by the controller 102 to implement the Heading to Rudder control mechanism.

Referring back to FIG. 3, at 310, a ‘Heading to Roll’ control may be utilized. This control may be used only at lower altitude where the wind magnitude is lower. Therefore, this control may only be used when the UAV 2 is below a predetermined altitude threshold, for example, 5-40 meters or about 20-30 meters. This control may be performed at 25 meters. In this lower altitude, higher priority is placed on controlling the UAV to maintain wings-level, i.e. leveling the UAV so that its lateral axis is substantially parallel with respect to the landing surface. This ‘Heading to Roll’ control is to ensure that the UAV lands with at most +/−10 degrees roll so as to prevent damage to the wings upon impact.

In the ‘Heading to Roll’ control, leveling of the UAV 2 may be performed. In an embodiment, when the UAV 2 is level (i.e. its lateral axis is parallel with the landing surface or ground) rudder 14 is at a trim position (e.g. not deflected or with only a small deflection). However, if the UAV 2 rolls to one side, rudder 14 may be deflected until the UAV 2 becomes level again (e.g. with a large deflection). For example, if the UAV 2 rolls to the right, the rudder 14 may deflect to the left. If the UAV 2 rolls to the left, the rudder 14 may deflect to the right. In this manner, the UAV 2 may maintain a level orientation. The deflection of the rudder 14 may be proportional to the amount of roll, i.e. how far off wings-level is the UAV. As mentioned above, the controller 102 may use the detector 106 to monitor the heading, roll and altitude. These values may be used by the controller 102 to implement the Heading to Roll control mechanism. In an embodiment, the detector 106 may be configured with a gyroscope and/or an accelerometer to measure the roll.

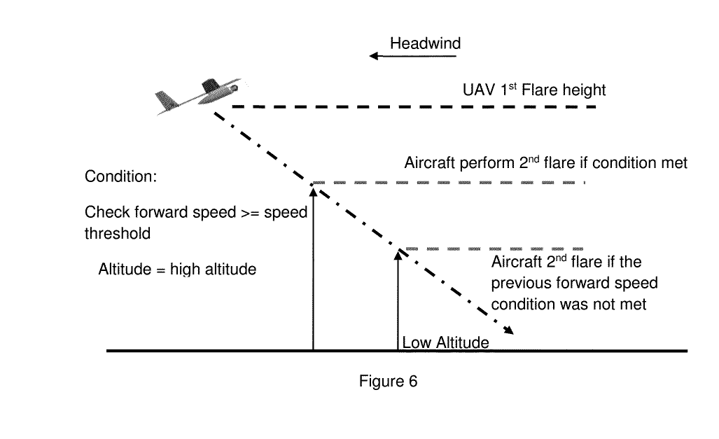

At 312, as the UAV 2 reaches closer to the ground, a second flare-maneuver is performed at between about 20 m or 30 m above ground, to further reduce the forward speed and descent rate and allow for a soft landing. As mentioned above, the second flare-maneuver may be performed by deflecting the elevator 16. The precise altitude at which the second flare-maneuver is performed may depend on the forward speed of the UAV 2. If the forward speed of the UAV is greater than or equal to a speed threshold (e.g. 5 m/s) at a higher altitude (e.g. 30 m), the second flare-maneuver may be performed at the higher altitude to reduce the forward speed earlier. If the forward speed is below the speed threshold at the higher altitude, the second flare-maneuver may be performed at a lower altitude (e.g. 20 m). A schematic diagram of this operation is shown in FIG. 6. After the second flare-maneuver, the UAV 2 naturally impacts the landing surface to land. At 314, once the UAV 2 has landed, the inflatable sleeve may be deflated.

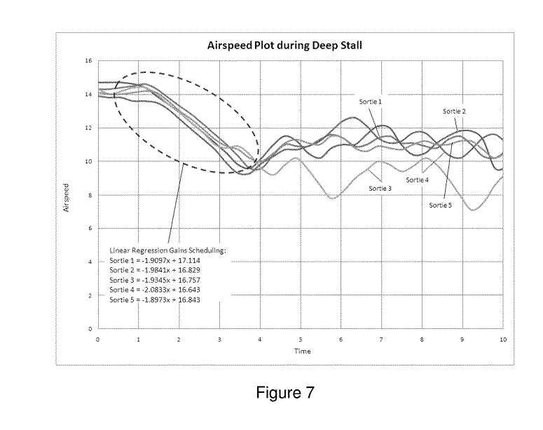

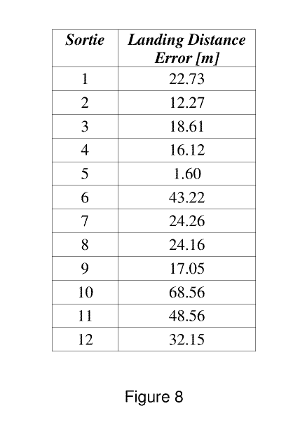

Now referring to FIG. 7, there is shown the speed plot of the UAV 2 during landing. Five flight trials are shown as Sorties 1-5. It can be seen that the speed of the UAV decreases from about 14 m/s to about 10 m/s after the first flare-maneuver, then fluctuates around 10 m/s thereafter. The landing distance errors of the five trials are shown in FIG. 8. An average error of about 27.44 m is obtained by performing the disclosed landing method. Accordingly, an advantage of the above-described embodiment is that it is possible to accurately land the UAV 2. This is made possible by actively controlling the UAV 2 through two flare-maneuvers and, in-between the flare-maneuvers, actively steering the UAV 2 into the wind.

An advantage of some embodiments is to ensure that the UAV lands with a small amount of forward speed to reduce damage compared to landing with no forward speed, such as when performing a deep-stall maneuver landing technique. Also, because the forward speed is small, the UAV is less likely to flip over on impact with the landing surface compared to a belly-landing technique. Further, since the landing descent is controlled, the UAV is less likely to be blow off-course and away from the landing position compared to a parachute landing technique. In this way, damage to the UAV may be reduced and landing accuracy may be improved.

An advantage of some embodiments is to provide a rudder control technique to steer the UAV into the wind direction with speed gain scheduling and heading region checking. In this way it is possible to prevent the UAV spiraling during descent.

An advantage of some embodiments is to maintain wings-level at lower altitude and before impact with the landing surface to prevent damage to the wings of the UAV.

It will be appreciated by a person skilled in the art that numerous variations and/or modifications may be made to one or more of the above-described embodiments without departing from the spirit or scope of the invention as broadly described in the appended claims. The above-described embodiments are, therefore, to be considered in all respects to be illustrative and not restrictive.

What is claimed:

1. A method for landing an unmanned aerial vehicle (UAV) in the presence of a wind, the method comprising:
performing a first flare-maneuver whilst the UAV is flying, the flare-maneuver causing a front portion of the UAV to rise with respect to a rear portion of the UAV;
steering the UAV along a path heading into a direction of the wind; and
performing a second flare-maneuver before the UAV impacts a landing surface to land.

2. The method of claim 1, further comprising inflating an inflatable sleeve connected to an underside of the UAV.

3. The method of claim 2, wherein the step of inflating is performed at the same time as performing the first flare-maneuver.

4. The method of claim 3, wherein the step of steering is performed after performing the first flare-maneuver.

5. The method of claim 4, wherein the first flare-maneuver is performed when the UAV is at an altitude between about 50 meters and about 110 meters.

6. The method of claim 5, wherein the second flare-maneuver is performed when the UAV is at an altitude between about 5 meters and about 40 meters.

7. The method of claim 6, wherein the altitude at which the first flare-maneuver and/or the second flare-maneuver are performed is dependent on a speed of the UAV.

8. The method of claim 7, further comprising:
leveling the UAV so that a lateral axis of the UAV is parallel with respect to the landing surface.

9. The method of claim 8, wherein the step of leveling is performed after performing the first flare-maneuver and before performing the second flare-maneuver.

10. The method of claim 1, wherein the front portion of the UAV rises by about 50 degrees- to about 60 degrees from horizontal with respect to the rear portion of the UAV during the first flare-maneuver and/or the second flare-maneuver.

11. The method of claim 10, wherein the front portion is a nose portion of the UAV and the rear portion is a tail portion of the UAV.

12. The method of claim 11, further comprising:
calculating a first-flare maneuver position based on a desired landing position and the direction of the wind, the first-flare maneuver position being a position at which the first-flare maneuver is to be performed; and
flying the UAV to the first-flare maneuver position before the step of performing the first flare-maneuver.

13. The method of claim 12, further comprising:
calculating a loiter position based on the first-flare maneuver position, the loiter position being a predetermined distance away from the first-flare maneuver position; and
flying the UAV to the loiter position before the step of flying the UAV to the first-flare maneuver position.

14. The method of claim 12, further comprising:
recalculating the first flare-maneuver position based on an updated speed and/ &r the direction of the wind before the step of performing the first flare-maneuver.

15. The method of claim 14, wherein the first flare-maneuver position includes a latitude value, a longitude value and an altitude value.

16. An unmanned aerial vehicle (UAV) comprising:
a controller;
a detector configured in use to determine a wind direction when the UAV is flying in the presence of a wind and to provide a wind direction indication to the controller; and
a steering and propulsion apparatus configured in use to steer and propel the UAV in flight in response to receiving instructions from the controller;
wherein the controller is configured in use to instruct the steering and propulsion apparatus to cause the UAV to:
perform a first flare-maneuver whilst flying, the flare-maneuver causing a front portion of the UAV to rise with respect to a rear portion of the UAV,
steer into the wind direction based on the wind direction indication, and
perform a second flare-maneuver before the UAV impacts a landing surface to land.

17. The UAV of claim 16, further comprising:
an inflatable sleeve connected to an underside of the UAV, the inflatable sleeve being configured in use to inflate in response to receiving an instruction from the controller.

18. The UAV of claim 17, further comprising:
a transceiver for exchanging data with a remote base station, the transceiver being capable of receiving position information from the remote base station and providing the position information to the controller,
wherein the controller is configured in use to instruct the steering and propulsion apparatus to steer and/or propel the UAV in flight based on the position information.

19. The UAV of claim 18, wherein the controller is configured in use to calculate updated position information based on the wind direction indication and to instruct the steering and propulsion apparatus to steer and/or propel the UAV in flight based on the updated position information.

20. The UAV of claim 19, wherein the controller is configured in use to instruct the steering and propulsion apparatus to level the UAV so that a lateral axis of the UAV is parallel with respect to the landing surface.

21. The UAV of claim 20, wherein the detector is further configured in use to detect a wind speed and to provide a wind speed indication to the controller, and the controller is further configured in use to instruct the steering and propulsion apparatus to steer and/or propel the UAV in flight based on the wind speed indication.
